(19) United States
(12) Patent Application Publication
(10) Pub. No.: US 2008/0036886 A1
(43) Pub. Date: Feb. 14, 2008

(54) Methods For Generating Enhanced Digital Images

(76) Inventors: Brett T. Hannigan, Menlo Park, CA (US); Alastair M. Reed, Lake Oswego, OR (US)

Correspondence Address: DIGIMARC CORPORATION, 9405 SW GEMINI DRIVE, BEAVERTON, OR, 97008, US

(21) Appl. No.: 11/748,851

(22) Filed: May 15, 2007

Related U.S. Application Data
(63) Continuation-in-part of application No. 09/895,063, filed on Jun. 29, 2001, now Pat. No. 7,218,751.

(51) Int. Cl. H04N 9/083

(52) U.S. Cl. 348/273

(57) ABSTRACT

Slight camera movement between capture of successive images is advantageously utilized to minimize or eliminate the need to interpolate in order to fill in the “holes” in a Bayer pattern. The captured color values from multiple appropriately positioned images are used to fill these holes. For example, instead of interpolating the value of red for the second pixel position on the first row of a Bayer pattern, an image is selected which is positioned one pixel to the right of the first image, and the red vales from this image are used for the red values of the second pixel on the first line. Values of the pixels in multiple images which are appropriately aligned to each pixel position are averaged to generate a better value for each pixel position. Information carried by a digital watermark (either alone or together with other techniques) is used to determine the alignment of the images. Images are selected which are positioned so that corresponding pixels fall within a specified tolerance from a location in a Bayer pattern. The pixel values of the images which fall within the specified tolerance of each pixel position in a Bayer pattern are selected and used for the alignment.

### RELATED APPLICATION DATA

This application is a continuation-in-part of copending application Ser. No. 09/895,063, filed Jun. 29, 2001 (now U.S. Pat. No. 7,218,751).

### TECHNICAL FIELD

The present technology relates to digital images, and more particularly to the processing of digital images to enhance same.

### BACKGROUND AND SUMMARY

The technology to detect and read digital watermarks that are embedded in images is well developed. For example see, U.S. Pat. Nos. 5,721,788, 5,745,604, 5,768,426, 5,748,783, 6,366,680, 6,424,725, 6,614,914, and U.S. application 20040264733 (these documents are incorporated herein by reference). Programs for detecting and reading digital watermarks are included in various commercially available image editing programs such as Adobe Photoshop that is marketed by Adobe Corporation.

A digital watermark can more easily be detected and read from a high quality, high resolution image, than from a low quality or low resolution image. In some situations multiple images having similar picture content are available. There are known techniques for combining multiple low resolution images which have similar content in order to make one relatively high resolution image. Such a technique is, for example, described in U.S. Pat. No. 6,208,765. The system shown in U.S. Pat. No. 6,208,765 aligns images using a reference coordinate system. An enhanced image is then synthesized, and regions of image overlap (i.e. regions of similar image content in multiple images) have improved quality. The synthesis process combines information in overlapping regions to form an enhanced image that corrects many of the image impairments.

Inexpensive low resolution cameras designed for connection to personal computers are in widespread use. Such cameras are herein referred to as PC cameras. PC cameras generally capture pixels in what is often termed a “Bayer pattern”. A Bayer pattern is a four pixel square where only one color is captured for each pixel. The colors captured for the two pixels on the first line are red and green. The colors captured for the two pixels on the second line are green and blue. Interpolation is used to calculate three colors for each pixel position. The positions in the Bayer pattern where values of colors are calculated rather than actually measured are herein termed “holes.”

If a camera which uses pixel interpolation is used to acquire a digital image of a watermarked physical image, the pixel interpolation may make it more difficult to accurately read the watermark from the acquired digital image. However, with cameras such as PC cameras, it is easy to obtain multiple images which have almost identical content. The present technology concerns, e.g., using such multiple images to minimize or eliminate the need to interpolate to obtain a high resolution image.

Aspects of the present technology are directed to producing a high resolution image from multiple images which have similar content. Where a camera such as a PC camera is used to acquire a digital image, in general, the camera will have slightly moved between when successive images are captured. With the present technology, such slight camera movement between when successive images are captured can be advantageously utilized to minimize or eliminate the need to interpolate in order to fill in the “holes” in a Bayer pattern.

With certain embodiments of the present technology, the captured color values from multiple appropriately positioned images are used to fill in the “holes” in a Bayer pattern. For example, instead of interpolating the value of red for the second pixel position on the first row of a Bayer pattern, an image is selected which is positioned one pixel to the right of the first image, and the red values from this image are used for the red values of the second pixel on the first line. Furthermore, the value of the pixels in multiple images which are appropriately aligned to each pixel position can be averaged to generate a better value for each pixel position.

In certain embodiments of the present technology, information carried by a digital watermark (either alone or together with other techniques) can be used to determine the alignment of the images. Images are selected which are positioned so that corresponding pixels fall within a specified tolerance from a location in a Bayer pattern. That is, images are selected that are within a specified tolerance of one pixel to the right or one pixel down from a reference frame. The pixel values of the images which fall within the specified tolerance of each pixel position in a Bayer pattern are selected and combined to form a high resolution image.

### BRIEF DESCRIPTION OF THE DRAWINGS

FIG. 1 illustrates a system for capturing multiple images which have similar content.

FIG. 2 illustrates the Bayer patterns in an image.

FIG. 3 illustrates how four low images can be combined to fill in the holes in a Bayer pattern without using interpolation.

FIG. 4 is a flow diagram illustrating the operation of one embodiment.

### DETAILED DESCRIPTION

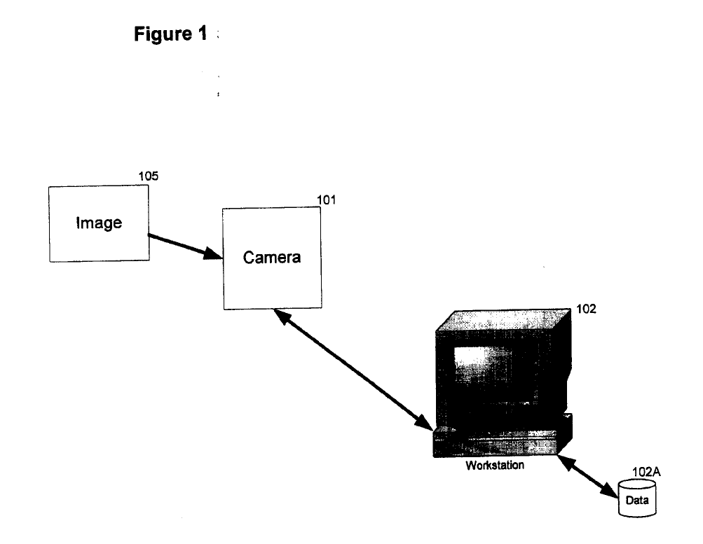

The first preferred embodiment utilizes the technology to facilitate reading digital watermarks from images captured by an inexpensive camera that is connected to a personal computer. FIG. 1 is an overall diagram of the system used to practice the first embodiment.

The system shown in FIG. 1 includes a camera 101 connected to a personal computer 102. The computer 102 has a storage system 102A that stores programs and images. The camera 101 is directed at a physical image 105. The physical image 105 includes a digital watermark. The watermark could for example have been embedded in image 105 using the commercially available image editing program Adobe Photoshop. As is conventional with watermarks embedded with the Adobe Photoshop program, the digital watermark embedded in image 105 includes a “grid signal” and a “payload” signal that carries digital data.

Watermark reading programs, such as that included in the Adobe Photoshop program, use the grid signal to align and scale a captured image prior to reading the payload data from the watermark. In the frequency plane, (i.e. when the frequency of the grid signal is examined) the grid signal forms a recognizable pattern. The location and shape of this pattern indicates the rotation and scale of the image. When the image is adjusted to the correct rotation and scale, the size and location of the “watermark tile” (i.e. the redundant pattern in the image that carries the watermark) is such that watermark payload signal can be easily read.

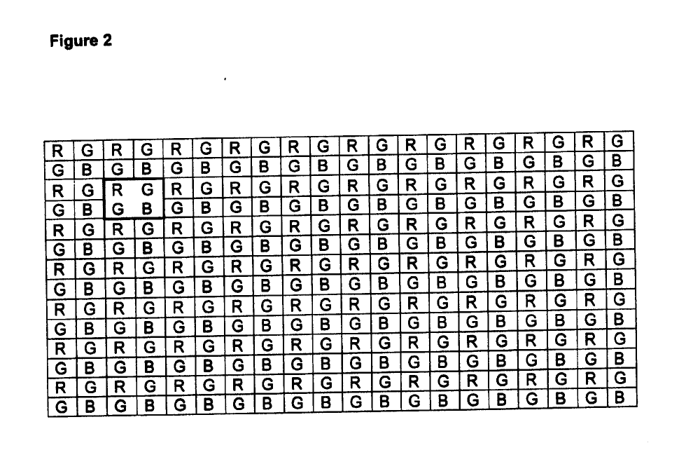

The camera 101 can for example be the camera marketed by the Intel Corporation under the trademark “Intel PC Camera Pro Pack” Such a camera is relatively inexpensive and it produces an image with a 640 by 480 resolution. The camera has detectors positioned in a 640 by 480 configuration; however, each detector only captures one color. The color captured by each detector is that specified by a Bayer pattern. FIG. 2 illustrates how colors are captured in a Bayer pattern. There is a “hole” for each color not captured at a particular location. In the prior art, interpolation is used to determine the values of the colors for the “holes” in the Bayer pattern. With certain embodiments of the present technology, interpolation is not required to fill in the holes in the Bayer pattern.

It is possible to read a watermark from an image captured by a camera when interpolation is used to fill in the holes in a Bayer pattern. However, when interpolation is used to fill the holes in a Bayer pattern, the camera must be correctly positioned (i.e. within a relatively small tolerance) with respect to the image and in some situations, several attempts to read an image may be required. Aspects of the present technology are directed to making it easier to read digital watermarks from images captured by a relatively low resolution camera.

The conventional PC camera 101 can capture individual images or it can capture multiple images at a rate of up to 30 frames per second. The camera 101 is controlled by a computer program. With the present technology, values from multiple images can be used to fill in the holes in a Bayer pattern to create a relatively high resolution image.

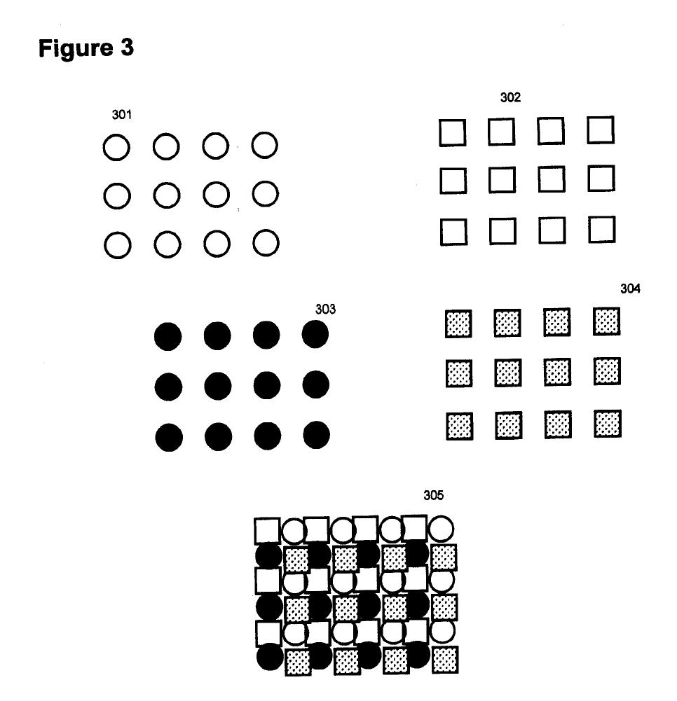

FIG. 3 illustrates (in a greatly exaggerated form) how the red color from four relatively low resolution images 301 to 304 can be combined into the red color for one relatively high resolution image. The red pixels in image 301 are represented by outline circles, the red pixels in image 302 are represented by outline squares, the red pixels in image 303 are represented by solid circles and, the red pixels in image 304 are represented by solid squares. Only the red pixels (i.e. the pixels in the upper left hand corner of a Bayer square are shown in FIG. 3. It is should be understood that the other pixels are handled in a similar manner. Furthermore, FIG. 3 only shows a small number of pixels; naturally in an actual image there would be many such pixels.

The four images 301 to 304 are combined as indicated by the alternating squares and circles in image 305. In order for the process to produce a useful result, the images must be aligned, so that corresponding pixels from the various images are next to each other, one pixel to the right and/or one pixel down as shown in FIG. 3. The alignment must be within a certain tolerance, which in this particular embodiment is one tenth of a pixel width. If the initial images have a resolution of 640 by 480 as produced by the Intel PC camera, and if the image is ten inches square, the pixels must be aligned to the locations in a Bayer pattern to within 0.012 inches. A very slight movement of the camera which captured the images could produce images so positioned.

With the present technology, the camera 101 is used to capture multiple images. For example in one second it can capture 30 images. The images are captured at a high frame rate so that the relative location of the physical image 105 and the camera are substantially (but not exactly) the same for all images.

As an example, consider the red pixel in a Bayer square and consider a corresponding pixel (herein called the reference pixel) in each of the 30 images captured during a one second interval. With the present technology the 30 images can be divided into five categories. (for reference the four positions in a Bayer Square are herein referred to as positions 1 to 4).
1) Those images within 0.1 pixel of position 1 of the Bayer square.
2) Those images within 0.1 pixel of position 2 of the Bayer square.
3) Those images within 0.1 pixel of position 3 of the Bayer square.
4) Those images within 0.1 pixel of position 4 of the Bayer square.
5) The remaining images.

The pixel values in the sets of images designated 1, 2, 3, and 4 above are averaged generating four images that will be termed the four “averaged” images. The four averaged images are combined into one image as indicated in FIG. 3. That is, images 301 to 304 represent four averaged images.

In some situations, there may not be images found which are located in each of the desired positions. If there are no images in one of the categories, the other averaged images can be combined and the fourth pixel position can be determined by interpolation in accordance with the prior art.

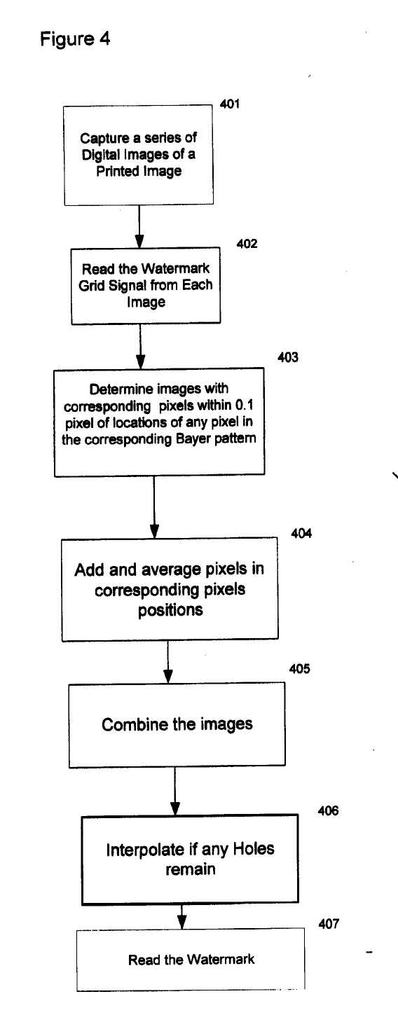

FIG. 4 is a block diagram of a computer program which performs operations of one embodiment of the present technology. As indicated by block 401, a series of images are captured with a PC camera. For example thirty images could be captured over a one second period. The operator will try to hold the camera such that the relative position of the camera and the printed image remain constant; however, there will almost always be some movement. Note, that the amount of movement that is relevant is the size of a pixel.

Next the watermark grid signal is read from each image and the relative position of each image is determined. As indicated by block 403, the images are divided into five categories as follows:
1) Those images within 0.1 pixel of position 1 of the Bayer square.
2) Those images within 0.1 pixel of position 2 of the Bayer square.
3) Those images within 0.1 pixel of position 3 of the Bayer square.
4) Those images within 0.1 pixel of position 4 of the Bayer square.
5) The remaining images.

Next as indicated by block 404, the pixel values from the images in each of the first categories are averaged to generate four images with average pixel values.

The four images with average pixel value are next combined into one image as indicated by block 405. The combination is as shown in FIG. 3.

If any holes remain in the Bayer blocks, these holes are filled in by interpolation in accordance with the prior art as indicated by block 406. The above described how the “red” color for each pixel in the high resolution image can be determined. The blue color for each pixel can be determined in a similar manner. The green pixels are also handled similarly; however, it is noted that for the green color there are two acquired pixels in each Bayer square, thus, there are less “holes” in the green color.

Finally, as indicated by block 407, the watermark payload data is read from the combined image in a conventional manner.

It is noted that in the first embodiment, a conventional watermark grid signal is used to align the images. In alternate embodiments, any reference signal which is inserted into the image can be used for alignment. For example a pseudo random noise pattern with good correlation properties or fiducial marks of some kind can be used. Preferably, the reference signal added to an image should not be visible to the human eye.

It is also noted that in the first embodiment described above only a watermark grid signal is used to align the images. In alternate embodiments, the alignment technique described herein can be used together with other known image alignment techniques, such as correlating image content, to align the images. Thus both a hidden reference signal as described with reference to the first embodiment and image content can be used to align images. The image content would be used to align the images as described in the prior art. The use of a combination of techniques in some situations will produce better alignment than the use of a single alignment technique.

In the embodiment shown, the images are combined in accordance with the positions of a Bayer square. It should be understood that other color patterns and other patterns of positions could be used in alternate embodiments.

While the technology has been shown and described with respect to preferred embodiments thereof, it should be understood that a wide variety of changes in form and design can be made without departing from the spirit and scope of this technology. The scope of the invention is limited only by the appended claims.

We claim:

1. A method of processing data captured by an image sensor having plural elements defining a first resolution, a first group of said elements positioned at a first set of locations and capturing light of a first color, a second group of said elements positioned at a second set of locations and capturing light of a second color, and a third group of said elements positioned at a third set of locations and capturing light of a third color, the sensor providing image data comprised of samples of single colors at different points in a scene, the method comprising:
capturing plural sets of image data using said image sensor;
determining alignment between captured sets of image data; and
combining color samples from said captured sets to yield enhanced image data, said enhanced data having the same first resolution, but including samples of plural colors at each of plural different points in the scene, rather than just samples of single colors at different points.

2. The method of claim 1 that also includes interpolating the enhanced image data to yield image data at a second resolution that is finer than the first resolution.

3. The method of claim 1 for processing data captured by an image sensor having red, green and blue light sensing elements arrayed according to a Bayer pattern, wherein at a point in the scene where the sensor provides a green light sample, also providing a red or blue light sample.

4. The method of claim 1 that includes determining alignment by reference to a pseudo random noise pattern within the scene.

5. The method of claim 1 that includes determining alignment by reference to a fiducial pattern within the scene.

6. The method of claim 1 that includes determining alignment by reference to a steganographic pattern within the scene.

7. The method of claim 1 wherein said determining alignment includes determining rotation of different of said sets of image data.

8. The method of claim 1 wherein said determining alignment includes determining scale of different of said sets of image data.

9. In a method of combining plural sets of image data to yield an enhanced set of image data, an improvement comprising determining rotation and/or scale of each of said sets of image data prior to said combining.

10. The method of claim 9 that includes determining rotation of each of said sets of image data prior to said combining.

11. The method of claim 9 that includes determining scale of each of said sets of image data prior to said combining.

12. In a method of combining plural sets of image data of a subject, to yield an enhanced set of image data of said subject, an improvement comprising aligning said sets of image data by reference to a steganographic registration pattern encoded in said subject.
